(19) United States
(12) Patent Application Publication
(10) Pub. No.: US 2026/0300309 A1
(43) Pub. Date: Oct. 1, 2026

(54) INFORMATION PROCESSING DEVICE, INFORMATION PROCESSING METHOD, AND PROGRAM

(71) Applicant: K.K. AMPLIFIED AI, Tokyo (JP)

(72) Inventors: Samuel DAVIS, Tokyo (JP); Christopher GRAINGER, Tokyo (JP); Yasuyuki OIKAWA, Tokyo (JP)

(21) Appl. No.: 19/477,009

(22) PCT Filed: Apr. 12, 2024
(86) PCT No.: PCT/JP2024/014816

§ 371 Date: Oct. 20, 2025

(30) Foreign Application Priority Data
Apr. 20, 2023 (JP) 2023-069570

(51) Int. Cl. G06F 16/248

(52) U.S. Cl. CPC G06F 16/248

(57) ABSTRACT

The purpose of the present invention is to make a response from an AI system appropriate for a user. A server acquires information inputted by a user to an input panel of a user interface, performs a search according to a search condition based on the acquired information by using a search, and displays a search result on an output panel of the user interface. The server acquires at least part of the search result displayed on the output panel as context information and transmits the acquired part to an AI system. The server receives generation information outputted from the AI system as a response to the transmission and presents the generation information or information based on the generation information to the user interface as provision information.

### TECHNICAL FIELD

The present invention relates to an information processing apparatus, an information processing method, and a program.

### BACKGROUND ART

In recent years, AI systems have come into use, in which an AI receives input information from a user and composes a sentence or the like as a response thereto (for example, see Patent Document 1).

### CITATION LIST

### Patent Documents

Patent Document 1: Japanese 7081099

### DISCLOSURE OF THE INVENTION

### Problems to be Solved by the Invention

However, a response from a conversational system is required to be appropriate for the user, yet conventional techniques, including Patent Document 1, have not been able to satisfy the requirement sufficiently.

The present invention has been made in view of such circumstances, and aims to ensure that a response from an AI system becomes appropriate for the user.

### Means for Solving the Problems

In order to achieve the above object, the information processing apparatus according to one aspect of the present invention includes:
a search control unit configured to execute control to acquire information entered by a user, and to perform a search for one or more items of information as a search result, in accordance with a search condition based on the information acquired;
an information generation system communication control unit configured to execute control of communication with an information generation system that executes a predetermined task using context information and outputs an execution result as generated information, the control including transmitting at least a portion of the search result as the context information to the information generation system, and receiving, in response to the transmission, the generated information output from the information generation system; and
an information presentation unit configured to present the generated information acquired, or information based on the generated information, as provided information to the user.

An information processing method and a program of one aspect of the present invention each correspond to the information processing apparatus of one aspect of the present invention.

### Effects of the Invention

The present invention enables a response from an AI system to be appropriate for the user.

### BRIEF DESCRIPTION OF THE DRAWINGS

FIG. 1 is a diagram illustrating an overview of the present service to which an information processing system is applied, including a server according to an embodiment of the information processing apparatus of the present invention;

FIG. 2 is a diagram illustrating an example of the configuration of an information processing system that realizes the provision of the present service illustrated in FIG. 1, namely, an information processing system including a server according to an embodiment of the information apparatus of the present invention;

FIG. 3 is a block diagram illustrating an example of the hardware configuration of the server in the information processing system illustrated in FIG. 2;

FIG. 4 is a functional block diagram illustrating an example of the functional configuration of the server in FIG. 3, in the information processing system in FIG. 2;

FIG. 5 is a diagram illustrating a first embodiment of the user interface as applied in the present service illustrated in FIG. 1;

FIG. 6 is a diagram illustrating a second embodiment of the user interface as applied in the present service illustrated in FIG. 1;

FIG. 7 is a diagram illustrating a third embodiment of the user interface as applied in the present service illustrated in FIG. 1;

FIG. 8 is a diagram illustrating a third embodiment of the user interface as applied in the present service illustrated in FIG. 1, continuing from the example in FIG. 7;

FIG. 9 is a diagram illustrating a fourth embodiment of the user interface as applied in the present service illustrated in FIG. 1;

FIG. 10 is a diagram illustrating an example of the user interface adopted in a fifth embodiment, as applied in the present service illustrated in FIG. 1;

FIG. 11 is a diagram illustrating a fifth embodiment of the user interface as applied in the present service illustrated in FIG. 1;

FIG. 12 is a supplementary diagram for the fifth embodiment of the user interface as applied in the present service illustrated in FIG. 1

FIG. 13 is a diagram illustrating a sixth embodiment of the user interface as applied in the present service illustrated in FIG. 1 and

FIG. 14 is a diagram illustrating a seventh embodiment of the user interface as applied in the present service illustrated in FIG. 1.

### PREFERRED MODE FOR CARRYING OUT THE INVENTION

Hereinafter, embodiments of the present invention will be described with reference to the drawings.

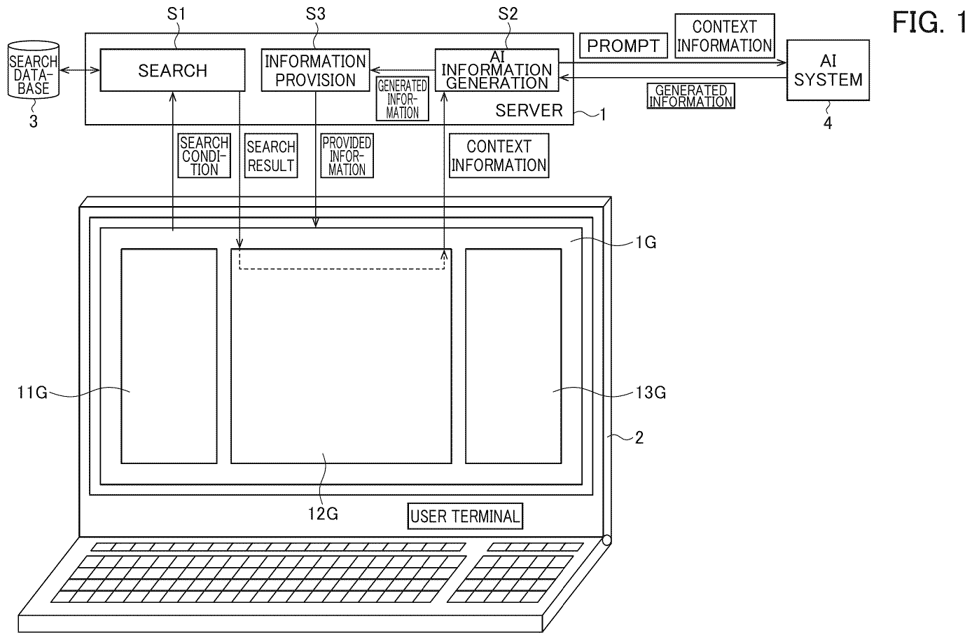

First, with reference to FIG. 1, an overview of a service (hereinafter, “the present service”) is provided, to which an information processing system, including a server according to an embodiment of the information processing apparatus of the present invention, is applied. FIG. 1 is a diagram illustrating an overview of the present service to which an information processing system, including a server according to an embodiment of the information processing apparatus of the present invention, is applied.

The present service is provided to a user who operates a user terminal 2, by a service provider that manages a server 1. In the present service, for example, a user using a user interface 1G enters a search condition, then a search result based on the search condition is displayed. Further, information suitable for the user is generated and provided by an AI system 4, such as a text generation AI, using the search result.

Specifically, for example, the display unit of the user terminal 2a displays a user interface 1G under control of the server 1. The user interface 1G includes an input panel 11G, an output panel 12G, and a discussion panel 13. The input panel 11G is a region in which a user enters a search condition, or information serving as a basis for the search condition. The output panel 12G is a region that displays a result (search result) searched in accordance with the search condition. The discussion panel 13G is a region in which a user can leave a note, chat with another user (including a chatbot), or share a file, a URL, or the like.

In the present service, in Step S1, the server 1 acquires information entered by the user into the input panel 11G of the user interface 1G, uses a search database 3 to perform a search in accordance with a search condition based on the acquired information, and causes the output panel 12G of the user interface 1G to display the search result.

Here, for example, the AI system 4 is configured as a text generation AI, and performs a predetermined task using context information (such as document drafting), and outputs the execution result as the generated information. In Step S2, the server 1 acquires at least a portion of the search result displayed in the output panel 12G of the user interface 1G as context information, transmits the context information together with a prompt for performing the predetermined task to the AI system 4. The server 1 receives the generated information output from the AI system 4 as a response to the transmission.

In Step S3, the server 1 presents the generated information acquired, or information based on the generated information, as provided information to the user via the user interface 1G. A location for presenting the provided information is not particularly limited, as long as the location is within the screen of the display unit of the user terminal 2. Namely, the provided information is presented at any location appropriate for the content and type of the provided information.

In this manner, instead of using the user input information itself as the context information, a search result based on the user's search condition is used as the context information, generated information is generated by the AI system 4, and the generated information is provided to the user as a response. In the conventional approach, user input information itself is used as the context information, but in many cases a response from an AI system is inappropriate for the user. Accordingly, in order to obtain context information that makes a response from an AI system suitable for the user, a user devises the input information laboriously. In contrast, in the present service, a user only enters a desired search condition, or information based thereon, a highly accurate search result aligned with the search condition is obtained, and at least a portion of the search result is used as the context information. Namely, without laboriously generating context information personally, the user only needs to enter a desired search condition (or information based thereon), thereby automatically generating context information for the AI system 4 to generate information appropriate for the user. In other words, without laboriously generating context information personally, the user only needs to enter a desired search condition (or information based thereon), allowing the response from the AI system 4 to become appropriate for the user.

Furthermore, in a case where the user's input information includes highly confidential information, it is inappropriate to transmit the user's input information as context information to the AI system 4, from a security standpoint. In this respect, in the present service, instead of the highly confidential information itself, public information in the form of a search result is transmitted as the context information to the AI system 4, and the highly confidential information will not leak to the outside, which is highly suitable from a security standpoint.

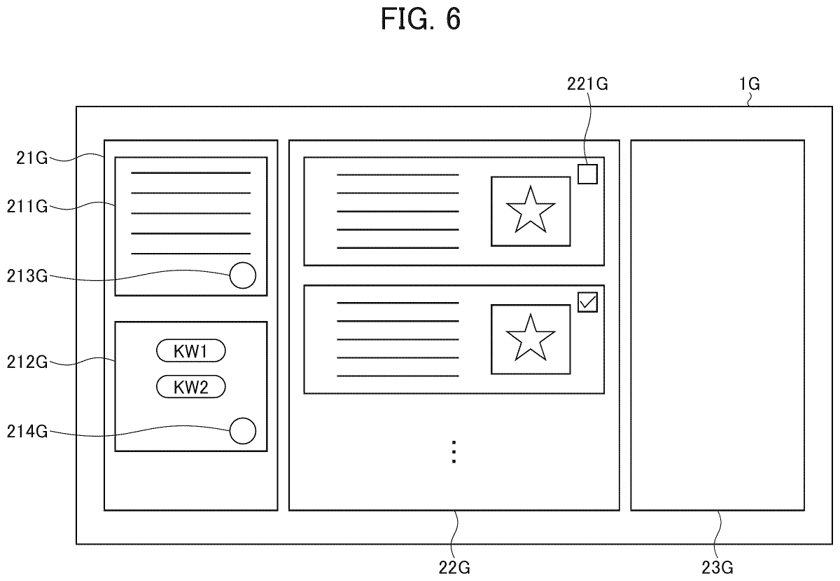

Here, not all of the search result but a portion specified by the user is transmitted as the context information to the AI system 4, whereby a response from the AI system 4 becomes even more appropriate for the user. This aspect of a user specifying a portion to be used as the context information from among the search result will be described later in, for example, the second embodiment illustrated in FIG. 6.

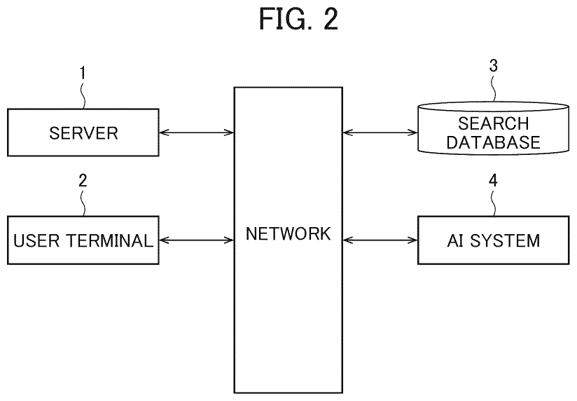

Next, with reference to FIG. 2, a configuration of an embodiment of the information processing system of the present invention, namely, an information processing system that realizes provision of the present service described above, will be described. FIG. 2 is a diagram illustrating an example of the configuration of an information processing system that realizes provision of the present service in FIG. 1, namely, an information processing system including a server in an embodiment of the information apparatus of the present invention.

The information processing system illustrated in FIG. 2 includes a server 1, a user terminal 2, a search database 3, and an AI system 4. The server 1, the user terminal 2, the search database 3, and the AI system 4 are mutually connected via a network (such as the Internet).

The server 1 is an information processing apparatus managed by a service provider of the present service in FIG. 1. The server 1 executes various processing for realizing the present service, while communicating as appropriate with the user terminal 2, the search database 3, and the AI system 4.

The user terminal 2 is an information processing apparatus operated by a user, and is configured with, for example, a smartphone, a tablet, or a personal computer.

The search database 3 outputs a search result based on a search condition specified by a search request source, back to the search request source (the server 1 in the present embodiment), and is configured as a database that stores various items of information that can constitute search results, in this example. The foregoing is merely illustrative, and as long as a search result based on a search condition specified by the search request source (the server 1 in the present embodiment) is output to the search request source, various forms, such as a third-party search engine, can be adopted. An administrator of the search database 3 may be the service provider of the present service, or may be a third party (in relation to the service provider).

As described above, the AI system 4 is a third-party system (in relation to the service provider), such as a text generation AI, which performs a predetermined task using context information and outputs an execution result as generated information. In this example, an LLM (Large Language Model) is adopted as an AI model.

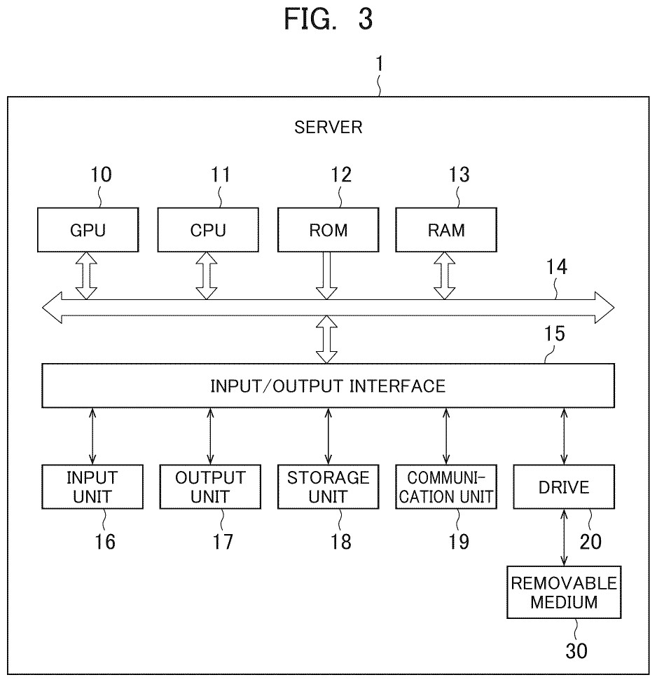

FIG. 3 is a block diagram illustrating an example of the hardware configuration of the server in the information processing system illustrated in FIG. 2.

The server 1 includes a GPU (Graphics Processing Unit) 10, a CPU (Central Processing Unit) 11, a ROM (Read Only Memory) 12, a RAM (Random Access Memory) 13, a bus 14, an input/output interface 15, an input unit 16, an output unit 17, a storage unit 18, a communication unit 19, and a drive 20.

The GPU 10 executes various processing in accordance with a program recorded in the ROM 12, or a program loaded from the storage unit 18 into the RAM 13. The GPU 10 uses data recorded in the storage unit 18, and data recorded in a database including the search database 3, and executes, for example, processing by a neural network not illustrated. The CPU 11 executes various processing in accordance with a program recorded in the ROM 12, or a program loaded from the storage unit 18 into the RAM 13. Data necessary for the CPU 11 to execute various processing are stored, as appropriate, in the RAM 13.

The CPU 11, the ROM 12, and the RAM 13 are mutually connected via the bus 14.

The input/output interface 15 is also connected to the bus 14. The input unit 16, the output unit 17, the storage unit 18, the communication unit 19, and the drive 20 are connected to the input/output interface 15.

The input unit 16 is constituted by, for example, a keyboard, and is used to input various items of information. The output unit 17 is constituted by a display such as a liquid crystal display, or a speaker, and outputs various items of information as images or audio.

The storage unit 18 is constituted by DRAM (Dynamic Random Access Memory) or the like, and stores various data. The communication unit 19 communicates with other devices via a network N including the Internet (for example, the server 1 in FIG. 3, or a third-party system server 5).

A removable medium 30, composed of a magnetic disk, an optical disk, a magneto-optical disk, or a semiconductor memory, is mounted in the drive 20 as appropriate. A program read from the removable medium 30 by the drive 20 is installed, as necessary, in the storage unit 18. The removable medium 30 can also store various data stored in the storage unit 18, in the same manner as the storage unit 18.

Although not illustrated, the user terminal 2 also has the hardware configuration illustrated in FIG. 3. Accordingly, a description of the hardware configuration of the user terminal 2 is omitted.

Various processing for providing the present service in FIG. 1 can be executed through cooperation between various hardware components illustrated in FIG. 3 and various software components of the information processing system in FIG. 2 including the server 1, the user terminal 2, the search database 3, and the AI system 4.

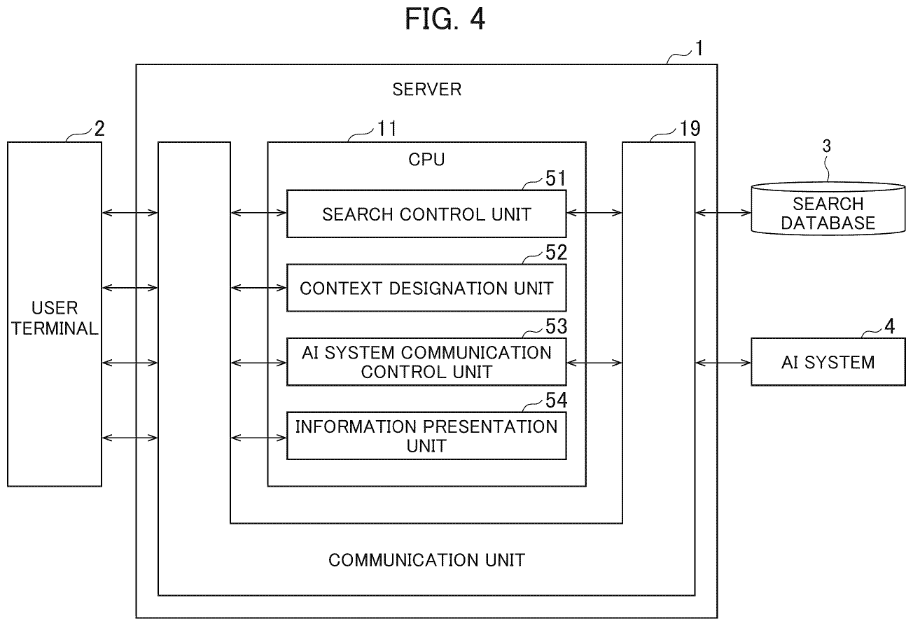

FIG. 4 is a functional block diagram illustrating an example of the functional configuration of the server in FIG. 3, in the information processing system in FIG. 2.

As illustrated in FIG. 4, a search control unit 51, a context designation unit 52, an AI system communication control unit 53, and an information presentation unit 54 operate in the CPU 11 of the server 1.

The search control unit 51 executes control to acquire information entered by the user from the user terminal 2 (information entered into the input panel 11G of the user interface 1G in the example in FIG. 1), and to perform a search using the search database 3 in accordance with a search condition based on the acquired information, thereby acquiring one or more items of information from the search database 3 as the search result. The search control unit 51 causes the user terminal 2 (the output panel 12G of the user interface 1G in the example in FIG. 1) to display the search result.

Here, as described above, the AI system 4 is a system that performs a predetermined task using context information and outputs an execution result as generated information. The AI system communication control unit 53 executes control of communication with the AI system 4, in which the control includes transmitting at least a portion of the search result as the context information to the AI system 4, and receiving, in response to the transmission, the generated information output from the AI system 4.

Here, the expression “at least a portion of the search result” for the context information transmitted to the AI system 4 signifies that either the entirety or a portion of the search result may be used. Furthermore, in a case where a portion of the search result constitutes the context information, the server 1 may autonomously determine, or the user may specify, which portion of the search result should be adopted as the context information. In the latter case, namely, in the case where the user uses the user terminal 2 to specify a portion of the search result to be used as the context information, the context designation unit 52 operates in the server 1.

The context designation unit 52 presents the search result to the user via the user terminal 2 (the output panel 12G of the user interface 1G in the example in FIG. 1), and accepts an operation by the user to specify a portion to be used as the context information from among the search result. The AI system communication control unit 54 executes control to transmit the portion specified by the user from among the search result to the AI system 4, as the context information, and to receive, in response to the transmission, the generated information output from the AI system 4.

The information presentation unit 54 presents the generated information acquired, or information based thereon, as provided information to the user via the user terminal 2 (the user interface 1G in the example in FIG. 1).

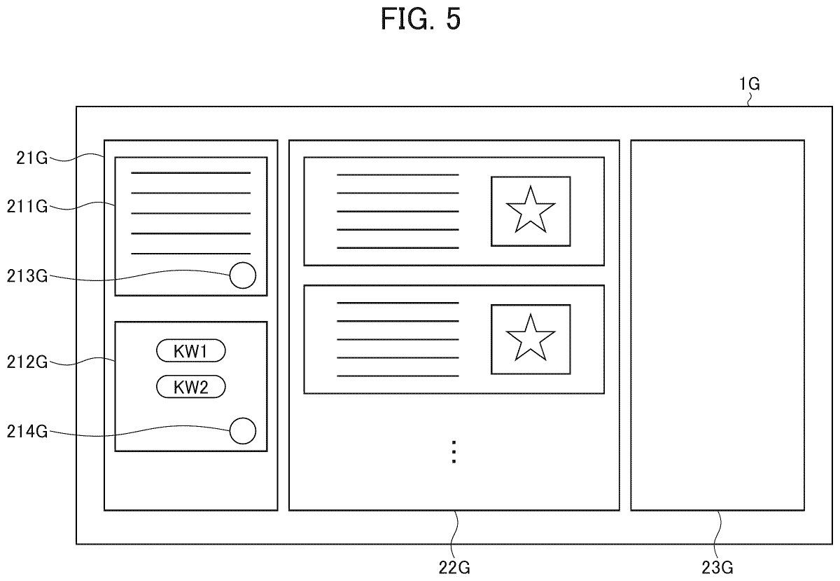

Furthermore, the functional configuration of the server 1 in FIG. 4 will be described using various embodiments of the user interface 1G illustrated in FIGS. 5 to 14.

FIG. 5 is a diagram illustrating a first embodiment of the user interface as applied in the present service illustrated in FIG. 1. In the first embodiment in FIG. 5, as a search condition, a user inputs text into a text input region 211G of an input panel 21G, or inputs a keyword in a keyword input region 212G of the input panel 21G. The search control unit 51 in the server 1 acquires the text or keyword serving as the search condition from the user terminal 2, performs a search using the search database 3 in accordance with the search condition, and acquires one or more items of information as the search result from the search database 3. The search control unit 51 causes an output panel 22G of the user interface 1G to display the search result. For example, when the user presses a button 213G within the input panel 21G, the AI system communication control unit 53 transmits the search result as text or images displayed in the output panel 22G, as the context information to the AI system 4. The AI system 4 performs a predetermined task of generating a better search text using the context information, and transmitting “a better search text” as the generated information to the server 1. The AI system communication control unit 53 receives “a better search text” as the generated information from the AI system 4. The information presentation unit 54 presents “a better search text” as the provided information to the user via the user interface 1G of the user terminal 2. Further, for example, when the user presses a button 214G within the input panel 21G, the AI system communication control unit 53 transmits the text or image among the search result displayed on the output panel 22G, as the context information to the AI system 4. The AI system 4 performs a predetermined task of generating “keywords suitable for search” (for a subsequent search) using the context information, and transmitting “keywords suitable for search” as the generated information to the server 1. The AI system communication control unit 53 receives “keywords suitable for search” as the generated information from the AI system 4. The information presentation unit 54 presents “keywords suitable for search” as the provided information to the user via the keyword input region 212 of the input panel 21G in the user interface 1G of the user terminal 2.

FIG. 6 is a diagram illustrating a second embodiment of the user interface as applied in the present service illustrated in FIG. 1. In the second embodiment in FIG. 6, as a search condition, a user inputs text into a text input region 211G of an input panel 21G, or inputs a keyword in a keyword input region 212G of the input panel 21G. The search control unit 51 in the server 1 acquires the text or keyword serving as the search condition from the user terminal 2, performs a search using the search database 3 in accordance with the search condition, and acquires one or more items of information as the search result from the search database 3. The search control unit 51 causes an output panel 22G of the user interface 1G to display the search result. The user specifies an item suited to the user's purpose (namely, a portion of the search result) from among the search result displayed on the output panel 22G. The context designation unit 52 accepts such a specification from the user. For example, when the user presses a button 213G within the input panel 21G, the AI system communication control unit 53 transmits the text or image specified by the user from among the search result displayed on the output panel 22G, as the context information to the AI system 4. The AI system 4 performs a predetermined task of generating a better search text using the context information and transmitting “a better search text” as the generated information to the server 1. The AI system communication control unit 53 receives “a better search text” as the generated information from the AI system 4. The information presentation unit 54 presents “a better search text” as the provided information to the user via the user interface 1G of the user terminal 2. Further, for example, when the user presses the button 214G within the input panel 21G, the AI system communication control unit 53 transmits the text or image specified by the user from among the search result displayed on the output panel 22G, as the context information to the AI system 4. The AI system 4 performs a predetermined task of generating “keywords suitable for search” (for a subsequent search) using the context information and transmitting “keywords suitable for search” as the generated information to the server 1. The AI system communication control unit 53 receives “keywords suitable for search” as the generated information from the AI system 4.

The information presentation unit 54 presents “keywords suitable for search” as the provided information to the user via the keyword input region 212 of the input panel 21G in the user interface 1G of the user terminal 2.

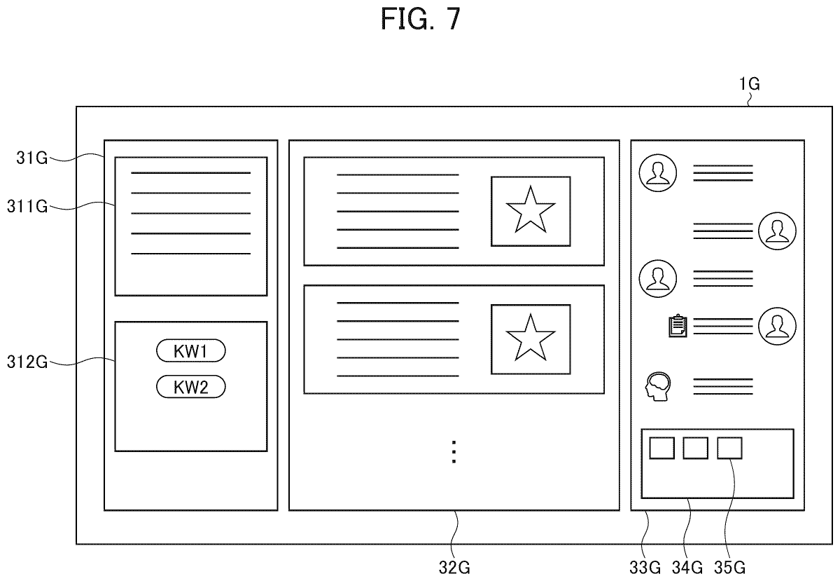

FIG. 7 is a diagram illustrating a third embodiment of the user interface as applied in the present service illustrated in FIG. 1. In the third embodiment in FIG. 7, the user using a discussion panel 33G of the user interface 1G can leave a note, chat with another user, or share a file or a URL. A region 34G below the discussion panel 33G receives text input from the user. As modes of text input, free-form text input using the input unit of the user terminal 2, such as a keyword, is acceptable, and entry by pressing a button 35G is also acceptable. The button 35G is designed for inputting template questions prepared on the server 1 (system) side. When the button 35G is pressed, a question from the user to the AI system 4 is entered into the region 34. Namely, in the example in FIG. 7, the AI system 4 performs a predetermined task of generating an answer to the question and outputting the answer as the generated information. Accordingly, when the user presses the button 35G within the discussion panel 33G, the AI system communication control unit 53 transmits the question associated with the button 35G to the AI system 4, and transmits the information retained in the discussion panel 33G (such as the chats between the user and another user, or information on the shared URL) as the context information to the AI system 4. The AI system 4 performs a predetermined task of generating an answer to the question using the context information and transmitting the “answer” as the generated information to the server 1. The AI system communication control unit 53 receives the “answer” as the generated information from the AI system 4. The information presentation unit 54 presents the “answer” as the provided information to the user via the user interface 1G of the user terminal 2.

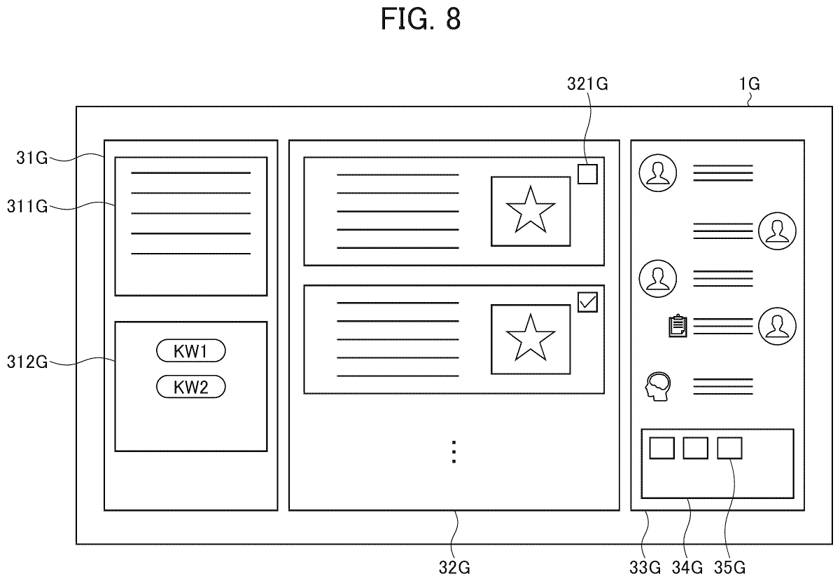

FIG. 8 is a diagram illustrating a third embodiment of the user interface as applied in the present service illustrated in FIG. 1, continuing from the example in FIG. 7. In the example in FIG. 8, as the context information to be transmitted to the AI system 4, in addition to the information retained in the discussion panel 33G in the example in FIG. 7, a portion specified by the user from among the search result displayed on an output panel 32G (a specific document with a checkbox 321G checked in the example in FIG. 8) is also adopted. Namely, when the user presses the button 35G within the discussion panel 33G, the AI system communication control unit 53 transmits the question associated with the button 35G to the AI system 4, and transmits the information retained in the discussion panel 33G and the portion specified by the user from among the search result (the specific document with the checkbox 321G checked in the example in FIG. 8) as the context information to the AI system 4. The AI system 4 performs a predetermined task of generating an answer to the question using the context information and transmitting the “answer” as the generated information to the server 1. The AI system communication control unit 53 receives the “answer” as the generated information from the AI system 4. The information presentation unit 54 presents the “answer” as the provided information to the user via the user interface 1G of the user terminal 2.

A question associated with the button 35G is not particularly limited. For example, a question such as “generate a search input text aligned with the context” (text to be entered into a text input region 311G of an input panel 31G) can be adopted. Further, for example, a question such as “generate keywords suitable for search aligned with the context” (keywords to be entered into a keyword input region 312G of the input panel 31G) can be adopted. Further, for example, a question such as “extract highly relevant documents from among the search results displayed on the output panel 32G” can be adopted.

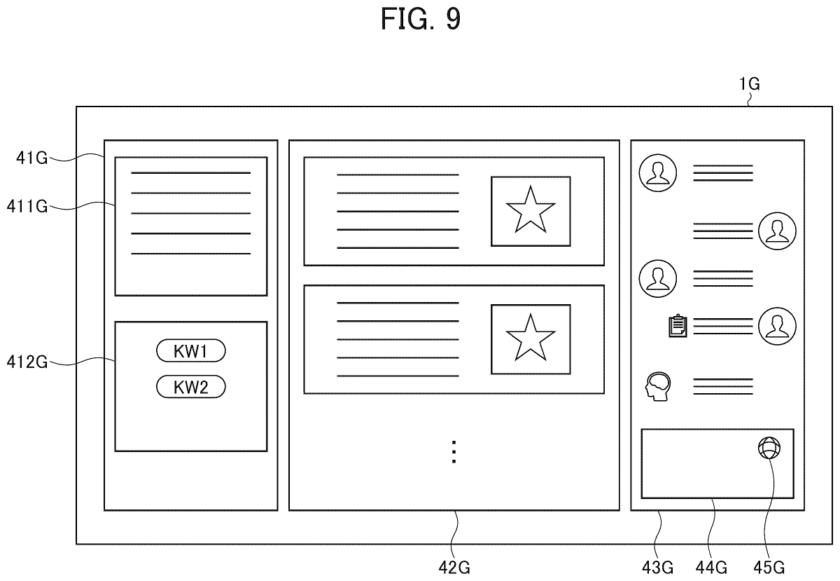

FIG. 9 is a diagram illustrating a fourth embodiment of the user interface as applied in the present service illustrated in FIG. 1. In the fourth embodiment in FIG. 9, a user using a discussion panel 43G of the user interface 1G can leave a note, chat with another user, or share a file or a URL. A region 34G below the discussion panel 43G receives text input from the user. As modes of text input, free-form text input using the input unit of the user terminal 2, such as a keyword, is acceptable, and entry by pressing a button 45G is also acceptable. A user can enter, into the region 44, text for requesting the AI system 4 to perform a search of external resources. The AI system communication control unit 53 transmits the request entered into the region 44 to the AI system 4, and transmits the information retained in the discussion panel 43G (such as the chats between the user and another user, or information on the shared URL) as the context information to the AI system 4. The AI system 4 performs a predetermined task of a search of external resources in accordance with the request using the context information and transmitting “a result of a search of external resources” as the generated information to the server 1. The AI system communication control unit 53 receives “a result of a search of external resources” as the generated information from the AI system 4. The information presentation unit 54 presents “a result of a search of external resources” as the provided information to the user via the user interface 1G of the user terminal 2. Here, external resources are not particularly limited, and may include, for example, a search on the Internet, a data service linked via an API, or an in-house file server.

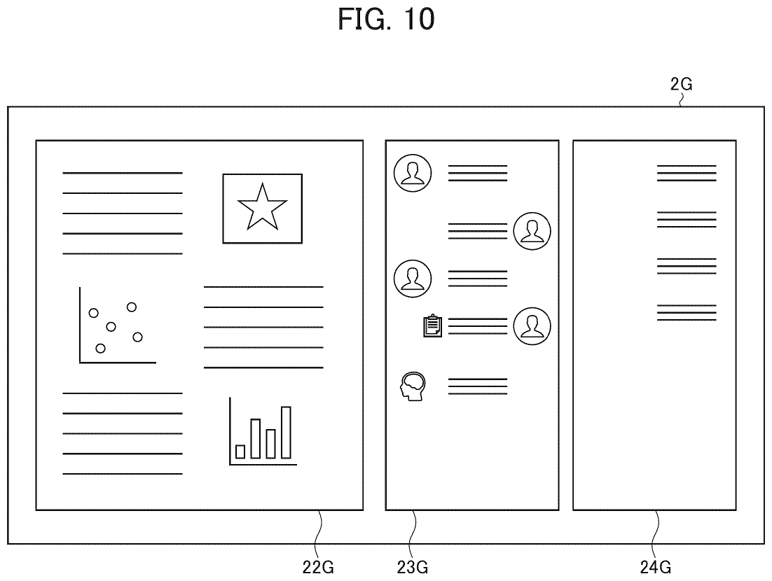

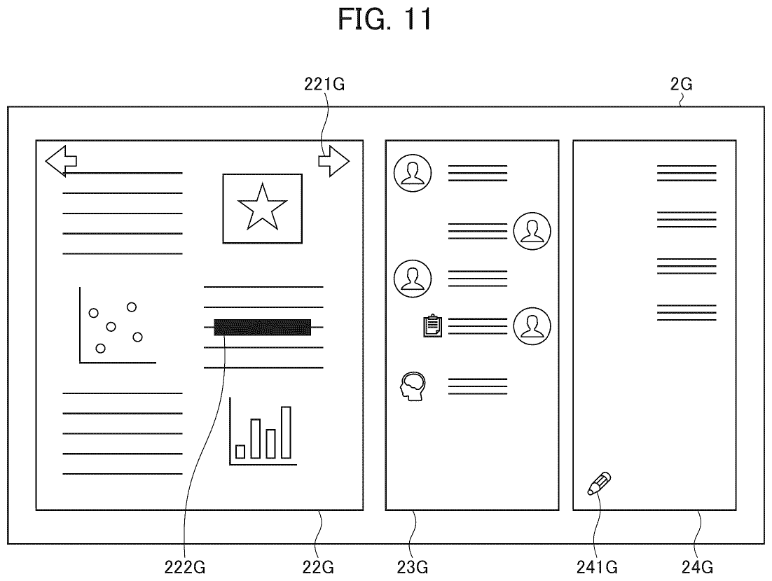

FIG. 10 is a diagram illustrating an example of the user interface adopted in a fifth embodiment, as applied in the present service in FIG. 1. A user interface 2G in the fifth embodiment illustrated in FIG. 10 (and in FIGS. 11 to 13 described later) is displayed on a display unit of the user terminal 2 under control of the server 1. The user interface 2G includes a text panel 22G, a discussion panel 23G, and a document drafting panel 24G. The text panel 22G is a region in which the full text of a document obtained as a result of a search performed by the AI system 4 using the user interface 1G in FIG. 1, or the like, is displayed. The discussion panel 23G is a region in which the user leaves a message, chats with another user (including a chatbot), or shares a file, a URL, or the like. The document drafting panel 24G is a region in which the user creates a text, such as a report or an essay.

FIG. 11 is a diagram illustrating the fifth embodiment of the user interface as applied in the present service illustrated in FIG. 1. A user can attach an annotation 222G to an important portion within the text of the document displayed in the text panel 22G of the user interface 2G. By pressing a button 241G in the document drafting panel 24G, the user can issue a request for processing such as drafting, appending, proofreading, or translating the text. The AI system communication control unit 53 transmits the request to the AI system 4, and transmits the information, such as the text entered into the document drafting panel 24G, the information retained in the discussion panel 23G (such as the chats between the user and another user, or information on the shared URL), and the portion of the text panel 22G with the annotation 222G attached, as the context information to the AI system 4. The AI system 4 performs a predetermined task of processing such as drafting, appending, proofreading, or translating the text in accordance with the request using the context information, and transmitting “a result of processing such as drafting, appending, proofreading, or translating the text” as the generated information to the server 1. The AI system communication control unit 53 receives “a result of processing such as drafting, appending, proofreading, or translating the text” as the generated information from the AI system 4. The information presentation unit 54 presents “a result of processing such as drafting, appending, proofreading, or translating the text” as the provided information to the user via the user interface 1G of the user terminal 2. The user presses a page-forward button 221G of the text panel 22G to change the document displayed in the text panel 22G, attaches the annotation 222G as needed, and presses the button 241G to repeat the series of operations described above. Namely, while reading various texts by pressing the page-forward button 221G, the user can create a suitable document on the document drafting panel 24G.

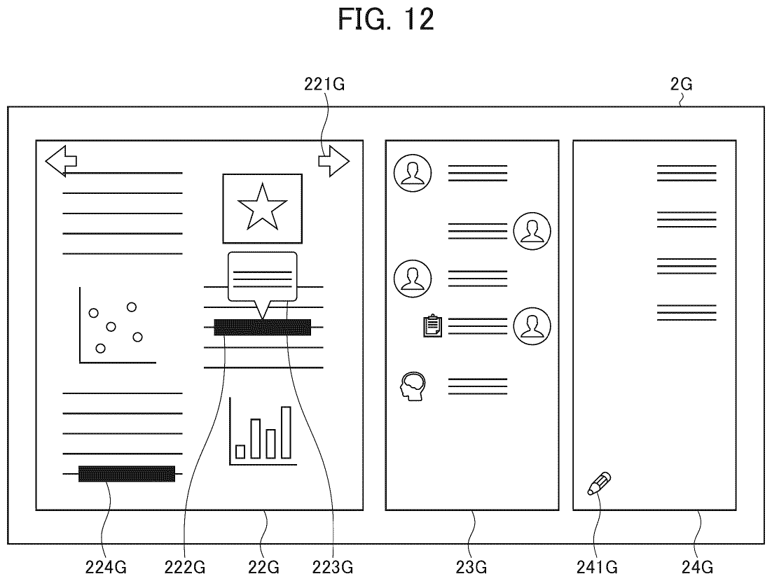

FIG. 12 is a diagram illustrating a supplementary example of the fifth embodiment of the user interface as applied in the present service illustrated in FIG. 1. For example, by using the entirety of the text of the document displayed in the text panel 22G as context, the user can request the AI system 4 to generate an explanation or interpretation for a portion with the annotation 222G attached. The AI system communication control unit 53 transmits the request to the AI system 4 and transmits the entirety of the text of the document displayed in the text panel 22G as the context information to the AI system 4. The AI system 4 performs a predetermined task of creating the text “explanation or interpretation of the portion with the annotation 222G attached” in accordance with the request using the context information, and transmitting the text “explanation or interpretation of the portion with the annotation 222G attached” as the generated information to the server 1. The AI system communication control unit 53 receives the text “explanation or interpretation of the portion with the annotation 222G attached” as the generated information from the AI system 4. The information presentation unit 54 presents the text “explanation or interpretation of the portion with the annotation 222G attached” as the provided information to the user via the user interface 1G of the user terminal 2. Specifically, in the example in FIG. 12, the text “explanation or interpretation of the portion with the annotation 222G attached” is displayed in a balloon 223G in relation to the annotation 222G. Further, for example, the user can request the AI system 4 to extract other portions, which are highly relevant to the portion with the annotation 222G attached, within the document displayed in the text panel 22G. The AI system communication control unit 53 transmits the request to the AI system 4, and transmits, the entirety of the text of the document displayed in the text panel 22G as the context information to the AI system 4. The AI system 4 using the context information performs a predetermined task of extracting “other portions highly relevant to the portion with the annotation 222G attached”, and transmits “other portions highly relevant to the portion with the annotation 222G attached” as the generated information to the server 1. The AI system communication control unit 53 receives “other portions highly relevant to the portion with the annotation 222G attached” as the generated information from the AI system 4. The information presentation unit 54 presents “other portions highly relevant to the portion with the annotation 222G attached” as the provided information to the user via the user interface 1G of the user terminal 2. Specifically, in the example in FIG. 12, an indicator 224G indicates the portions, which are highly relevant to the portion with the annotation 222G attached, within the text of the document displayed in the text panel 22G.

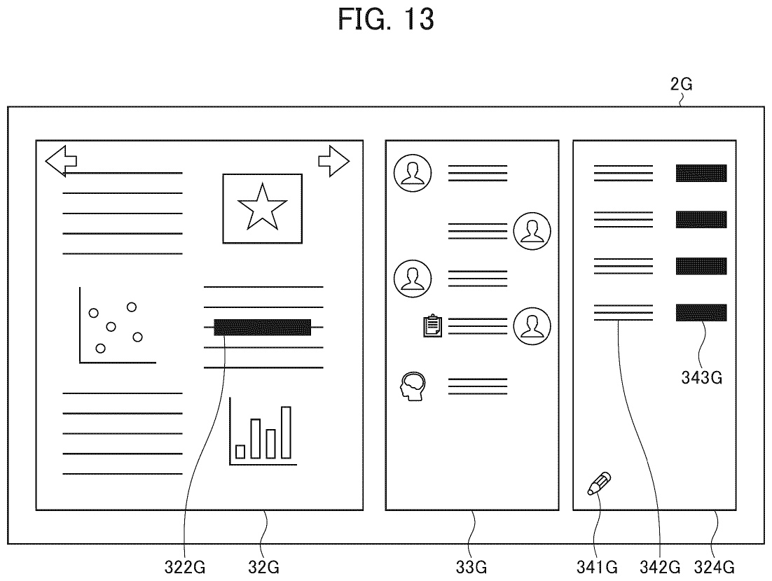

FIG. 13 is a diagram illustrating a sixth embodiment of the user interface as applied in the present service illustrated in FIG. 1. In the sixth embodiment as well, the user interface 2G in FIG. 10 is adopted in the same manner as in the fifth embodiment. By pressing a button 341G within a document drafting panel 324G, the user can issue a request to extract portions similar to text 342G created by the user (hereinafter, “user-created text 342G”), from within the text of the document displayed in the text panel 22G. The AI system communication control unit 53 transmits the request (including the user-created text 342G) to the AI system 4, and transmits the entirety of the text of the document displayed in the text panel 22G as the context information to the AI system 4. The AI system 4 using the context information performs a predetermined task of extracting “portions similar to the user-created text 342G” in accordance with the request and transmits “portions similar to the user-created text 342G” as the generated information to the server 1. The AI system communication control unit 53 receives “portions similar to the user-created text 342G” as the generated information from the AI system 4. The information presentation unit 54 presents “portions similar to the user-created text 342G” as the provided information to the user via the user interface 1G of the user terminal 2. Specifically, in the example in FIG. 13, the document drafting panel 342G displays the text 343G “portions similar to the user-created text 342G” side by side for comparison with the user-created text 342G, and an indicator 322G indicates the portions, which are similar to the user-created text 342G, within the text of the document displayed in the text panel 22G. When extracting “portions similar to the user-created text 342G” in accordance with the request, the AI system 4 may also adopt the information recorded in the discussion panel 33G as the context information.

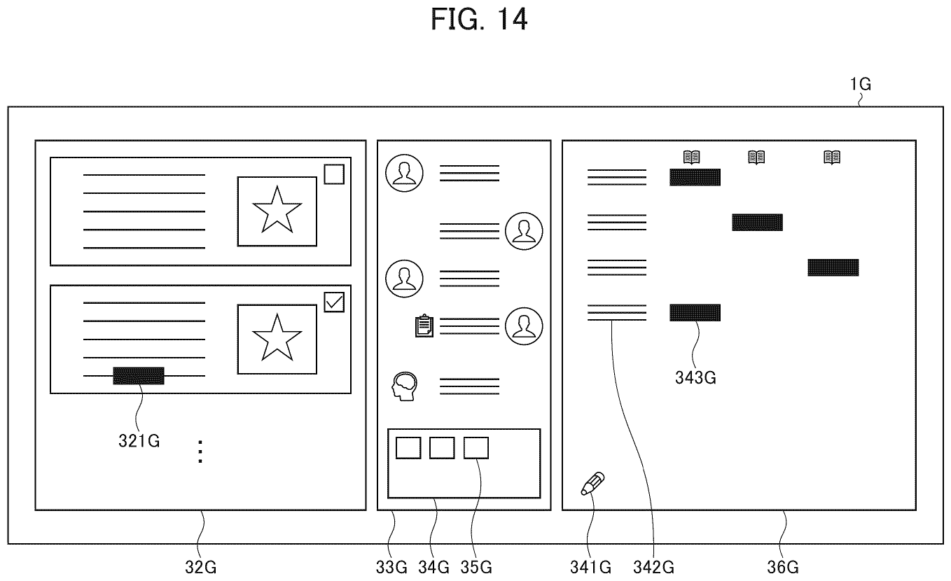

FIG. 14 is a diagram illustrating a seventh embodiment of the user interface as applied in the present service illustrated in FIG. 1. In the user interface 1G of the seventh embodiment in FIG. 14, in comparison with the user interface 1G of the other examples (FIG. 1 and FIGS. 5 to 8), an input panel is omitted, and a document drafting panel 36G is provided instead. The user specifies an item (one or more documents as a portion of the search result) suited to the user's purpose, from among the search result (a plurality of documents) displayed on the output panel 32G. The context designation unit 52 accepts such a specification from the user. By pressing the button 35G or 341G, the user can request the AI system 4 to extract portions similar to the user-created text 342G, from within the text of the one or more specified documents. The AI system communication control unit 53 transmits the request (including the user-created text 342G) to the AI system 4 and transmits the text of the one or more documents specified by the user from among the documents displayed on the output panel 32G, as the context information to the AI system 4. The AI system 4 using the context information performs a predetermined task of extracting “portions similar to the user-created text 342G” in accordance with the request and transmits “portions similar to the user-created text 342G” as the generated information to the server 1. The AI system communication control unit 53 receives “portions similar to the user-created text 342G” as the generated information from the AI system 4. The information presentation unit 54 presents “portions similar to the user-created text 342G” as the provided information to the user via the user interface 1G of the user terminal 2. Specifically, in the example in FIG. 14, the document drafting panel 36G displays the text 343G “portions similar to the user-created text 342G” side by side for comparison with the user-created text 342G, and the indicator 321G indicates “portions similar to the user-created text 342G” within the text of the documents displayed on the output panel 32G.

Next, although not illustrated, an eighth embodiment will be described. For example, assume that the output panel 12G of the user interface 1G in FIG. 1 displays a plurality of texts of documents (for example, approximately 10,000 items) as a search result. As a predetermined task, the AI system 4 generates generated information in bulk as “a response to a request for summary, or a question (such as asking to identify important portions)” for each of the plurality of documents. The AI system communication control unit 53 transmits the respective texts of the plurality of documents displayed as the search result on the output panel 32G, as the context information to the AI system 4. The AI system 4 using the context information performs the predetermined task described above, and transmits “a response to a request for summary, or a question (such as asking to identify important portions) in each of the plurality of documents as the search result” as the generated information to the server 1. The AI system communication control unit 53 receives “a response to a request for summary, or a question (such as asking to identify important portions) in each of the plurality of documents as the search result” as the generated information from the AI system 4. The information presentation unit 54 returns “a response to a request for summary, or a question (such as asking to identify important portions) in each of the plurality of documents as the search result” as the generated information from the AI system 4, to the search system (the search database 3 in the embodiments described above) in a searchable form. Here, “the plurality of documents as the search result” are the data originally stored in the database (the search database 3 in the embodiments described above). Accordingly, “a response to a request for summary, or a question (such as asking to identify important portions in each of the plurality of documents as the search result” as the generated information from the AI system 4 can be recognized as “extended data aligned with the user's search purpose”. Namely, the server 1 causes the AI system 4 to generate the extended data aligned with the user's search purpose, as the generated information, based on the content of predetermined data among the data stored in a predetermined database (for example the search database 3), and returns the extended data to the predetermined database. As a result, a search for data including the extended data can be performed. Here, when the server 1 causes the predetermined database (for example the search database 3) to index “a response to a request for summary, or a question (such as asking to identify important portions)in each of the plurality of documents as the search result” as the generated information from the AI system 4, the server 1 may perform, in addition to a normal word-level index, an index based on vector representations by a large language model, or by a neural network specific to the present service. By executing such processing at high speed, the server 1 can execute distributed processing, not only on the CPU 11 but also on the GPU 10, to convert the generated information from the AI system 4 into a searchable state with virtually no time lag from generation. A target for executing the distributed processing may be a locally provided GPU such as the GPU 10 in the server 1, and is not particularly limited, and a GPU on a cloud may be rented as well.

Although embodiments of the present invention have been described above, the present invention is not limited to the embodiments described above, and modifications and improvements within a scope capable of achieving an object of the present invention are regarded as included in the present invention.

For example, in FIG. 4, the search control unit 51 performs a search by itself in the embodiments described above but need only perform control of a search. Here, “control of a search” is a concept that encompasses execution of a search by the information processing apparatus (the server 1), as well as acquisition of a search result by causing another apparatus, such as a search engine, to perform a search.

For example, as a text generation AI or the like, the AI system 4 (cloud-based AI system 4) is adopted as another service in the embodiments described above; however, an AI of the service provider of the present service may be adopted. In other words, a text generation AI or the like may be provided within the server 1. Accordingly, communication control by the AI system communication control unit 53 in FIG. 4 is a concept that encompasses communication within an apparatus (the server 1), in addition to inter-device communication via the Internet as in the embodiments described above.

The system configuration illustrated in FIG. 2, and the hardware configurations of the server 1 and the user terminal 2 illustrated in FIG. 3, are merely examples for achieving an object of the present invention and are not particularly limited.

The functional block diagram illustrated in FIG. 4 is merely illustrative and is not particularly limited. Namely, as long as the information processing system in FIG. 4 is furnished with functions capable of executing, as a whole, the various processing described above, the types of functional blocks and databases used for realizing these functions are not particularly limited to the example in FIG. 5.

Locations of functional blocks and databases are not limited to those in FIG. 4, and may be determined arbitrarily. For example, at least a portion of the functional blocks and databases disposed on the server 1 may be provided by another information processing apparatus.

The series of processing described above may be executed by hardware, or may be executed by software. A single functional block may be configured solely by hardware, solely by software, or by a combination thereof.

In a case where the series of processing is executed by software, a program constituting the software is installed into a computer from a network or from a recording medium. The computer may be a computer embedded in dedicated hardware. The computer may also be a computer capable of executing various functions by installing various programs, for example a server of a service provider, a general-purpose smartphone, or a personal computer.

A recording medium including such a program is constituted not only by a removable medium, not illustrated, distributed separately from a main apparatus to provide the program to a user, but also by a recording medium provided to the user in a state pre-incorporated in the main apparatus.

In the present specification, steps that describe a program recorded on a recording medium include processing executed chronologically in accordance with the order of the steps, and also include processing not necessarily executed chronologically, namely processing executed in parallel or individually.

To summarize the foregoing, the information processing apparatus to which the present invention is applied need only include the configuration described below, and may take various forms. Namely, the information processing apparatus (for example, the server 1 in FIGS. 1 to 4), to which the present invention is applied, need only include: a search control unit (for example, the search control unit 51 in FIG. 4) configured to execute control to acquire information entered by a user (for example, information entered into the input panel 11G in FIG. 1), and to perform a search for one or more items of information as a search result (for example, search using the search database 3 in FIG. 1, FIG. 2, and FIG. 4), in accordance with a search condition based on the acquired information; an information generation system communication control unit (for example, the AI system communication control unit 54 in FIG. 4) configured to execute control of communication with an information generation system (for example, the AI system 4 in FIG. 1, FIG. 2, and FIG. 4, configured as a text generation AI or the like) that executes a predetermined task using context information and outputs an execution result as generated information, in which the control includes transmitting at least a portion of the search result (for example, a search result of documents displayed in the output panel 12G in FIG. 1) as the context information to the information generation system, and receiving, in response to the transmission, the generated information output from the information generation system; and an information presentation unit (for example, the information presentation unit 54 in FIG. 4) configured to present the generated information acquired, or information based on the generated information, as provided information to the user. Here, “information based on the generated information” that may constitute the provided information refers to the information obtained as a result of applying modification, processing (including partial alteration, addition, or reduction of information), correction, or translation to the generated information, or the information newly generated using the generated information.

Furthermore, the information processing apparatus may further include a context designation unit (for example, the context designation unit 52 in FIG. 4) configured to present the search result to the user, and to accept an operation by the user to specify a portion to be used as the context information from among the search result (for example, an operation to specify the one (one or more documents) suited to the user's purpose from among the search results (a plurality of documents) displayed on the output panel 22G in FIG. 6)). The information generation system communication control unit may transmit the portion specified by the user from among the search result, as the context information to the information generation system.

The information generation system may perform the predetermined task of generating related information for the search result, and outputting the related information generated, as the generated information. Here, “related information” includes, for example, “a better search text” that is generated when the button 213 in FIG. 5 or FIG. 6 is pressed and is not particularly limited. Various types of information can be adopted, as long as the information relates to the search result, such as a summary of a document (such as a predetermined document).

The information generation system may perform the predetermined task of generated information to be used as the search condition for a subsequent search by the search control unit (for example “keywords suitable for search” (such as synonyms of the keywords used in an initial search) when the button 214 in FIG. 5 or FIG. 6 is pressed), and outputting the information as the generated information.

The information generation unit transmits information based on input by user to a predetermined display region on a predetermined screen, in addition to the portion specified by the user from among the search result, as the context information to the information generation system. For example, in the third embodiment in FIG. 8, the specific document with the checkbox 321G checked is adopted as “the portion specified by the user from among the search result”. The information retained in the discussion panel 33G is adopted as the “information based on input by user to a predetermined display region on a predetermined screen”. Further, in the fifth embodiment in FIG. 11, the information of portions within the text panel 222G, with the annotation 222G attached, is adopted as “the portion specified by the user from among the search result”. The information retained in the discussion panel 23G, and the text entered in the document drafting panel 24G, are adopted as the “information based on input by user to a predetermined display region on a predetermined screen”.

The information generation system may perform the predetermined task of generating an answer to a predetermined question (for example, in the third embodiment in FIG. 7, a question associated with the button 35G in the discussion panel 33G) and outputting the generated answer as the generated information. The information generation system communication control unit may execute control to transmit the information indicating the predetermined question together with the context information to the information generation system.

The information generation system may perform the predetermined task of at least one of drafting, appending, proofreading, or translating a predetermined text (for example, in the fifth embodiment in FIG. 11, a request for processing such as drafting, appending, proofreading, or translating the text is executed in response to pressing the button 241G in the document drafting panel 24G), and output the execution result as the generated information.

The information generation system may perform the predetermined task of extracting one or more items of information similar to predetermined information from the context information (see, for example, the sixth embodiment in FIG. 13, and the seventh embodiment in FIG. 14), and output the one or more extracted items of similar information as the generated information. The information generation system communication control unit may execute control to transmit the predetermined information together with the context information to the information generation system.

### EXPLANATION OF REFERENCE NUMERALS

1: server
2: user terminal
3: search database
4: AI system
11: CPU
12: ROM
13: RAM
14: bus
15: input/output interface
16: input unit
17: output unit
18: storage unit
19: communication unit
20: drive
30: removable medium
51: search control unit
52: context designation unit
53: AI system communication control unit
54: information presentation unit

1. An information processing apparatus, comprising:
a search control unit configured to execute control to acquire information entered by a user, and to perform a search for one or more items of information as a search result, in accordance with a search condition based on the information acquired;
an information generation system communication control unit configured to execute control of communication with an information generation system that executes a predetermined task using context information and outputs an execution result as generated information, the control including transmitting at least a portion of the search result as the context information to the information generation system, and receiving, in response to the transmission, the generated information output from the information generation system; and
an information presentation unit configured to present the generated information acquired, or information based on the generated information, as provided information to the user.

2. The information processing apparatus according to claim 1, further comprising:
a context designation unit configured to present the search result to the user, and to accept an operation by the user to specify a portion of the search result to be used as the context information,
wherein the information generation system communication control unit is configured to transmit the portion of the search result specified by the user, as the context information to the information generation system.

3. The information processing apparatus according to claim 1, wherein the information generation system is configured to perform the predetermined task of generating related information regarding the search result, and outputting the related information generated, as the generated information.

4. The information processing apparatus according to claim 1, wherein the information generation system is configured to perform the predetermined task of generated information to be used as the search condition for a subsequent search by the search control unit, and outputting the information generated, as the generated information.

5. The information processing apparatus according to claim 2, wherein the information generation unit is configured to transmit information based on input by the user to a predetermined display region on a predetermined screen, in addition to the specified by the user from among the search result, as the context information to the information generation system.

6. The information processing apparatus according to claim 5,
wherein the information generation system is configured to perform the predetermined task of generating an answer to a predetermined question, and outputting the answer generated, as the generated information, and
wherein the information generation system communication control unit is configured to transmit information indicating the predetermined question together with the context information to the information generation system.

7. The information processing apparatus according to claim 5, wherein the information generation system is configured to perform the predetermined task of at least one of drafting, appending, proofreading, or translating a predetermined text, and outputting an execution result of the predetermined task as the generated information.

8. The information processing apparatus according to claim 1,
wherein the information generation system is configured to perform the predetermined task of extracting one or more items of information similar to predetermined information from the context information, and outputting the extracted one or more items of information similar to the predetermined information as the generated information, and
wherein the information generation system communication control unit is configured to transmit the predetermined information together with the context information to the information generation system.

9. An information processing method executed by an information processing apparatus, the method comprising:
a search control step of executing control to acquire information entered by a user, and to perform a search for one or more items of information as a search result, in accordance with a search condition based on the information acquired;
an information generation system communication control step of executing control of communication with an information generation system that executes a predetermined task using context information and outputs an execution result as generated information, the control including transmitting at least a portion of the search result as the context information to the information generation system, and receiving, in response to the transmission, the generated information output from the information generation system; and
an information presentation step of presenting the generated information acquired, or information based on the generated information, as provided information to the user.

10. A non-transitory computer readable medium storing a program causing a computer to execute information processing, the information processing comprising:
a search control step of executing control to acquire information entered by a user, and to perform a search for one or more items of information as a search result, in accordance with a search condition based on the information acquired;
an information generation system communication control step of executing control of communication with an information generation system that executes a predetermined task using context information and outputs an execution result as generated information, the control including transmitting at least a portion of the search result as the context information to the information generation system, and receiving, in response to the transmission, the generated information output from the information generation system; and
an information presentation step of presenting the generated information acquired, or information based on the generated information, as provided information to the user.
